(19) United States
(12) Patent Application Publication
(10) Pub. No.: US 2021/0117872 A1
(43) Pub. Date: Apr. 22, 2021

(54) System and Method for Facilitating Vehicle Test Drives

(71) Applicant: Capital One Services, LLC, McLean, VA (US)

(72) Inventors: Joshua Edwards, Philadelphia, PA (US); Lukiih Cuan, Washington, DC (US); Matthew Tribble, Plano, TX (US)

(21) Appl. No.: 16/659,610

(22) Filed: Oct. 22, 2019

(51) Int. Cl. G06Q 10/02; G06Q 30/02

(52) U.S. Cl. CPC G06Q 10/02; G06Q 30/0203

(57) ABSTRACT

Aspects described herein may allow for vehicle test drive access. Systems and methods described herein may associate a user's request to test drive a vehicle that includes a set of user vehicle preferences pertaining to a vehicle that the user desires to test drive. The request is accompanied with information on the location of the user. The system and methods identify one or more test drive providers that possess a vehicle fulfilling a portion of the set of user vehicle preferences. Once a test drive provider is identified the system may suggest an optimal meeting location for the test drive provider and the test drive requester to meet, in order to conduct the test drive of the test drive provider's vehicle.

### FIELD OF USE

Aspects of the disclosure provide for systems and methods for the test driving of vehicles. More particularly, aspects of the disclosure may provide for enabling a potential vehicle purchaser to test drive a requested vehicle from different entities.

### BACKGROUND

Before purchasing a vehicle, whether that vehicle is new or used, it is typically the case that a potential vehicle purchaser would want to test drive the vehicle. For example, auto dealerships today may physically deploy people to parking lots and other locations to allow potential customers the ability to test drive vehicles. Additionally, potential customers may not always have access to a vehicle for a test drive, as auto dealerships may not be open 24 hours and/or may be closed on some days. Further, the potential vehicle purchaser may want to test drive a vehicle from an entity other than an auto dealership for any number of reasons, including not wanting to deal or interact with salespeople.

There are existing car sharing applications, such as Maven™ and Turo™, that allow a user to rent a car from a private party with the ability to avoid the typical car rental companies or car dealerships. With Maven™ or Turo™, the user may choose a specific type of vehicle to drive, whereby the user and the owner of the vehicle that the user desires to drive are provided with contact information, so that they can contact each other, or utilize a third party or server as an intermediary, for privacy concerns, to thereby meet and enable the user to obtain the car from the owner for a certain time period, such as a day, a couple of days, or a week.

While existing systems provide a user the ability to engage in a short term rental for a specific vehicle from a private person, there are no systems that facilitate test drives for a potential vehicle purchaser.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects discussed herein may provide a computer-implemented method for facilitating access to a vehicle to enable the vehicle to be test driven by a potential customer. The method may utilize modern technology to provide a user with access to a vehicle without the need for the user to go to a car dealership or car rental facility in order to test drive a vehicle of a same or similar make, model and year of manufacture that the user is interested in purchasing.

According to at least one aspect, a method for facilitating test driving of a vehicle may include receiving an input, from a computing device associated with a user, the input comprising a request to test drive a vehicle that includes a set of user vehicle preferences pertaining to a vehicle that the user desires to test drive, the input further comprising a location associated with the user. The method includes identifying, based on the input from the computing device and information stored in a vehicle information database, at least one test drive provider having a vehicle fulfilling a portion of the set of user vehicle preferences. The method continues by sending a request to the at least one test drive provider that the user desires to test drive the vehicle of the at least one test drive provider, and then receiving a response to the request sent to the at least one test drive provider, the response indicating that the at least one test drive provider accepts the request of the user to test drive the vehicle of the at least one test drive provider. The method then determines, based on data stored in a test drive providers database and the location associated with the user, a potential meeting location for the at least one test drive provider and the user, and sends a message to the user and to the at least one test drive provider regarding the potential meeting location.

In another embodiment, a method for facilitating test driving of a vehicle includes receiving an input, from a computing device associated with a user, the input comprising a request to test drive a vehicle, the request including a set of user vehicle preferences pertaining to a vehicle that the user desires to test drive, the input further comprising a location associated with the user. In this embodiment there is a determination that there does not exist at least one test drive provider with a vehicle matching at least a portion of the set of user vehicle preferences pertaining to a vehicle that the user desires to test drive, and a further determination, based on information stored in a vehicle information database, at least one test drive provider with a comparable vehicle having a similar set of user vehicle preferences. The method then sends a message to the user requesting whether the user would like to test drive the comparable vehicle, and then sending, upon receiving a positive response to the message to the user, a message to the test drive provider associated with the comparable vehicle that the user would like to test drive the comparable vehicle. The method then determines, based on data stored in a test drive providers database and the location associated with the user, a potential meeting location for the at least one test drive provider and the user, and sends a message to the user and to the at least one test drive provider regarding the potential meeting location. Further, the test drive provider includes a private individual, a dealership, a car rental company, or a ride share service.

These features, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example environment in accordance with one or more illustrative aspects discussed herein;

FIG. 3 depicts an example user interface for inputting vehicle information preferences and locations in accordance network in accordance with one or more illustrative aspects discussed herein;

FIG. 4 depicts an example test drive provider interface for inputting vehicle and location information in accordance network in accordance with one or more illustrative aspects discussed herein;

FIGS. 5 depicts an example of a user interface of a response from a test drive provider, in accordance with one or more illustrative aspects discussed herein; and

FIGS. 6-8 depict a flow diagrams of example methods for facilitating a vehicle test drive in accordance with one or more illustrative aspects discussed herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to systems, methods, techniques, apparatuses, and non-transitory computer readable media to facilitate test driving vehicles. For example, a user may register for a test driving service and indicate their preferences of what type of vehicle they wish to test drive. The user may also include contact or logistic information as to when and where the user may be during certain times of the day. Based on the vehicle preferences and location information, and based on location information of test drive providers, a suitable meeting location may be determined for the user to test drive a particular vehicle.

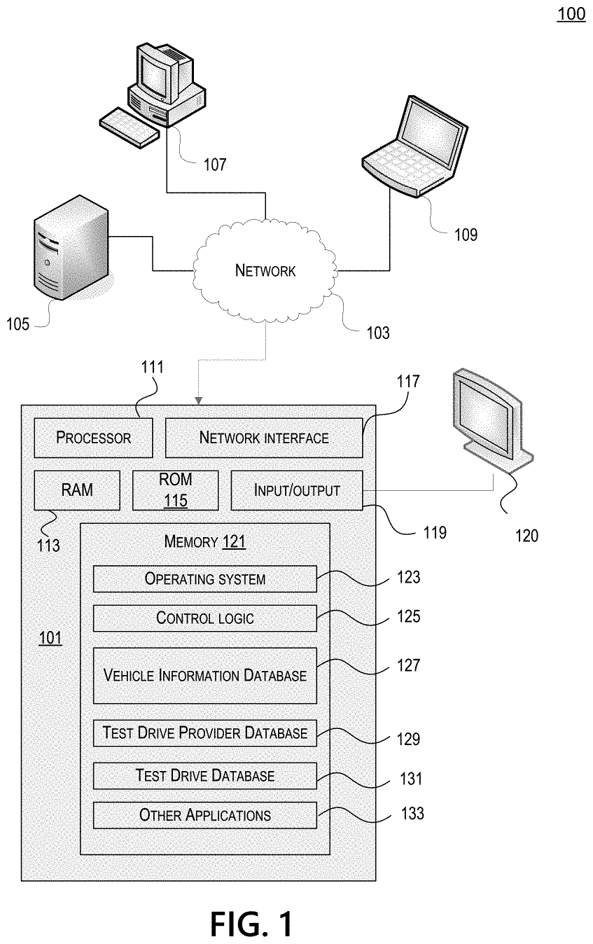

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topologies and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with database queries, interactions with client applications, scheduling and tracking of requests associated with requests for vehicle test drives, generating vehicle access for a user (e.g., for a test drive), tracking vehicle locations, calculating directions to/from a vehicle, and other functions. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein. Furthermore, memory 121 may store various databases and applications depending on the particular use, for example, vehicle information database 127, test drive provider database 129, test drive database 131, and other applications 133 may be stored in a memory of a computing device used at a server system that will be described further below. Control logic 125 may be incorporated in and/or may comprise a linking engine that updates, receives, and/or associates various information stored in the memory 121 (e.g., smart key storage device identifiers, vehicle and vehicle key identifiers, locking information, statuses, location information, directional information, etc.). In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, devices 101, 105, 107, 109, and others may operate in concert to provide parallel computing features in support of the operation of control logic 125 and/or vehicle information database 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Having discussed several examples of computing devices which may be used to implement some aspects as discussed further below, discussion will now turn to an illustrative environment and network for facilitating test driving of a vehicle.

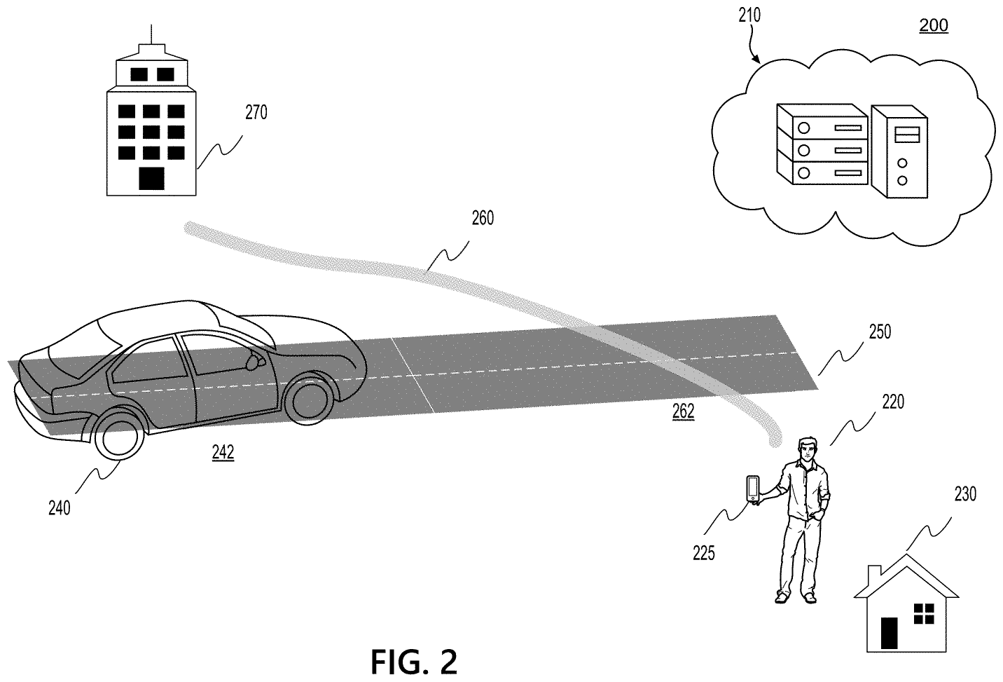

FIG. 2 depicts an example environment 200 in accordance with one or more illustrative aspects discussed herein. Environment 200 includes in at least one aspect, a local or remote server system 210, a user 220 with a mobile device 225 shown located at a house 230, a vehicle 240 at location 242 on a road 250, a path 260 that crosses road 250 at location 262 and an office building 270.

In an embodiment, user 220, using mobile device 225 would contact, either directly or through a server or third party entity, a test drive provider (not shown) utilizing a client application running on mobile device 225. The test drive provider may be a dealership, a rental facility, a ride sharing service, an investment entity, or a private party who owns or controls vehicle 240. User 220 would generate a request to test drive a vehicle. Such a request could include various preferences such as a particular manufacturer, a vehicle's manufacturer such as Ford™. The request could also include more specific attributes such as a model year, or year of manufacture. The request could also include other factors such as a specific model, e.g., Ford F150 truck, or merely a general description, e.g., a late model SUV. Further, vehicle 240 is to be broadly defined and can encompass any type of vehicle including motorcycles, recreational vehicles, kit cars, boats, personal watercraft and the like.

In an embodiment, user 220 could use computing device 101 to submit a request for a test drive. The request, either from computing device 101 or mobile device 225, may be sent to a remote or local server 210. User 220 may be given instructions that the desired vehicle is currently at a particular location 242. Or, the user may also be given instructions to enable the user to contact the test drive provider, to set up a convenient day and time of day to conduct the test drive of vehicle 240. Further, user 220 could request that vehicle 240 be delivered to user 220 at user 220's home 230, or at user 220's place of employment at building 270, or somewhere along path 260, possibly at location 262, that user 220 traverses on the way to work.

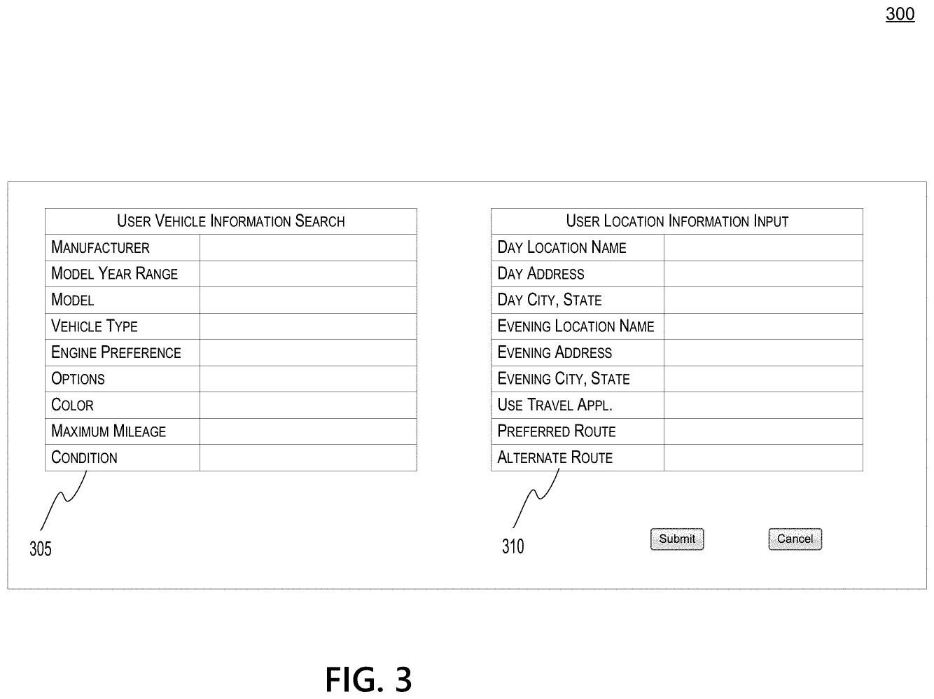

FIG. 3 depicts an example user interface 300 that a user may experience when registering for a test driving service, according to one or more illustrative aspects disclosed herein. After registering onto the test driving service, the user enters, in a vehicle information portion 305 of the user interface 300, a desired vehicle manufacturer, model year and model, for a vehicle that the user is interested in purchasing, or at least to test drive. Additionally or alternatively, the user may enter other information associated with a vehicle that the user desires to test drive. This may include, for example, (a) type of vehicle (e.g., compact, sedan, SUV, truck); (b) engine characteristics (e.g., 4 cylinder, 6 cylinders, 8 cylinder); (c) vehicle options (e.g., four-wheel drive, all-wheel drive, anti-lock braking system); (d) vehicle color and condition (e.g., very good with only minor body damage, good with some body damage); and/or (e) any other suitable information. The vehicle that the user desires to test drive may not necessarily be the same vehicle that the user may eventually purchase, but instead enables the user to determine, after having test driven the vehicle, whether or not such a vehicle manufacturer, model year and model is suitable for purchase by the user. For example, after having test driven a 2010 Honda Accord from a private party, the user may then purchase a 2010 Honda Accord from a Honda dealership, a local user car dealership, or from a car rental agency that is offering such a rental vehicle for sale.

After having entered in the vehicle manufacturer, model and model year (or range of manufacture years) that the user desires to test drive, the user also enters location information in a location selection portion 310 of the user interface 300. Location information may include a first location where the user is typically located during a first portion of the day, and a second location where the user is typically located during a second portion of the day. By way of example, the first location may be the user's home (e.g., 9125 Downtown St., Anywhere, Ohio at house 230) and the first portion of the day may be from 7 pm. to 7 am, and the second location may be the user's work location (e.g., 2265 Main Street, Nowhere, Ohio at building 270) and the second portion of the day may be from 8 am to 6 pm.

Additionally, in the location selection portion 310 of the user interface 300, the user may enter a preferred route that the user takes to go to/from the first location and the second location. For example, the user may enter the following: Maple Avenue to Oak Grove Road, to Route 93 West, to Arizona Avenue, to Main Street. The user may also enter an alternate route of travel between the first and second locations in the location selection portion 310 of the user interface 300. Alternatively, the user may select “use travel appl.” to have a travel application, such as MapQuest or Google Maps, determine a suitable travel path between the first and second locations, as well as a suitable alternate travel path between the first and second locations.

After having entered the above information via the user interface 300, the user selects the “Submit” button (or “Cancel” button if the user decides not to continue with the test drive application). The user-inputted information is provided to a server, such as local or remote server system 210 in FIG. 2, and compared against a database of test drive providers to determine if there is a suitable match for the user.

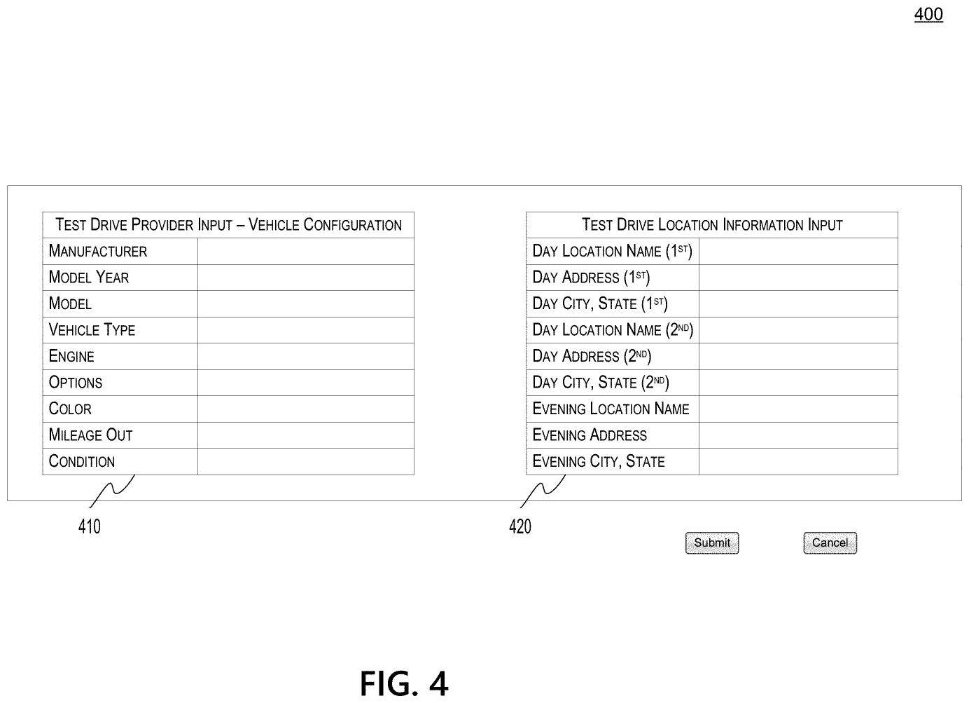

FIG. 4 shows a user interface 400 for a test drive provider according to aspects of the disclosure. The test drive provider may enter, in a vehicle information portion 410 of the user interface 400, a vehicle manufacturer, model and model year, for a vehicle that the test drive provider may allow others to test drive. The test drive provider may also enter, in a location selection portion 420 of the user interface, a location that the test drive provider may typically be located during the day. In a manner similar to location information entered by the user via the user interface 300, the test drive provider may enter more than one location that the test drive provider is typically located during the day, such as a first location that the test drive provider is located during a first portion of the day and a second location that the test drive provider is located during a second portion of the day.

The information entered by the test drive provider is stored in a database of test drive providers, along with information of other test drive providers who have registered for the text drive provider service. As explained above, if there is a match of at least one test drive provider with a user requesting a particular vehicle to test drive, then the user may be notified of the match. The user may then determine whether or not he/she is interested in meeting the test drive provider to arrange a convenient day and time of day to meet to conduct the test drive of the test drive provider's vehicle.

Based on the location information provided by the user and the location information provided by the test drive provider, the user may be informed as to an optimal meeting location for conducting the test drive. The optimal meeting location may be close to the user's home (the first location that the user is typically located during a first portion of the day), or it may be close to the user's work address (the second location that the user is typically located during a first portion of the day), or it may be a location on the primary travel route or the alternate travel route that the user takes to go from the first location to the second location, or vice versa.

The test drive provider may also be provided with the optimal meeting location, and, based on that information, as well as contact information of the user and the test drive provider (e.g., phone number for texting of calling, and/or email), the user and the test drive provider may agree to a particular day and time of day to meet at the optimal meeting location to conduct the test drive of the test drive provider's vehicle by the user, or they may agree to meet at a location other than the optimal meeting location.

According to some aspects, the test drive provider may be a car dealership having an inventory of used cars, a car rental facility having an inventory of rental cars, or a private party having a vehicle that the private party would allow another person to test drive for a fee. In each instance, compensation may be provided to the test drive provider based on their type. For example, a car dealership may be provided with no financial compensation, whereby they would be compensated by the fact that a user is test driving one of their vehicles and may purchase it if they like the vehicle. A car rental facility may also be provided with no financial compensation, whereby they would be compensated by the fact that a user is test driving one of their rental vehicles and may purchase it if they like the vehicle. A private party, on the other hand, may be provided with a financial compensation for allowing someone to test drive their vehicle. In addition, a third party, such as a dealership or any other third party platform, could be provided some type of compensation, or an additional amount of incentive if the individual ultimately purchases a vehicle from the dealership. The amount of financial compensation may be preset, such as $20 per test drive, or it may be mutually agreeable amount that the test drive provider private party and the test drive requester agree to between themselves. Further, the amount of compensation provided may be based on the number of times that users utilized a vehicle for a test drive associated with the test drive provider within a predetermined time period. And, the financial compensation may also be determined on a predetermined number of times the test provider has performed test drives.

Alternatively, by allowing others to test drive their vehicle, private parties may be provided with a free registration onto the test drive provider service, such that when a private party who has allowed others to test drive his/her vehicle desires to test drive a vehicle at some later point in time, the private party is allowed to access the test drive application and to test drive a vehicle owned by another person or entity without having to pay a fee (or by having to pay a reduced fee).

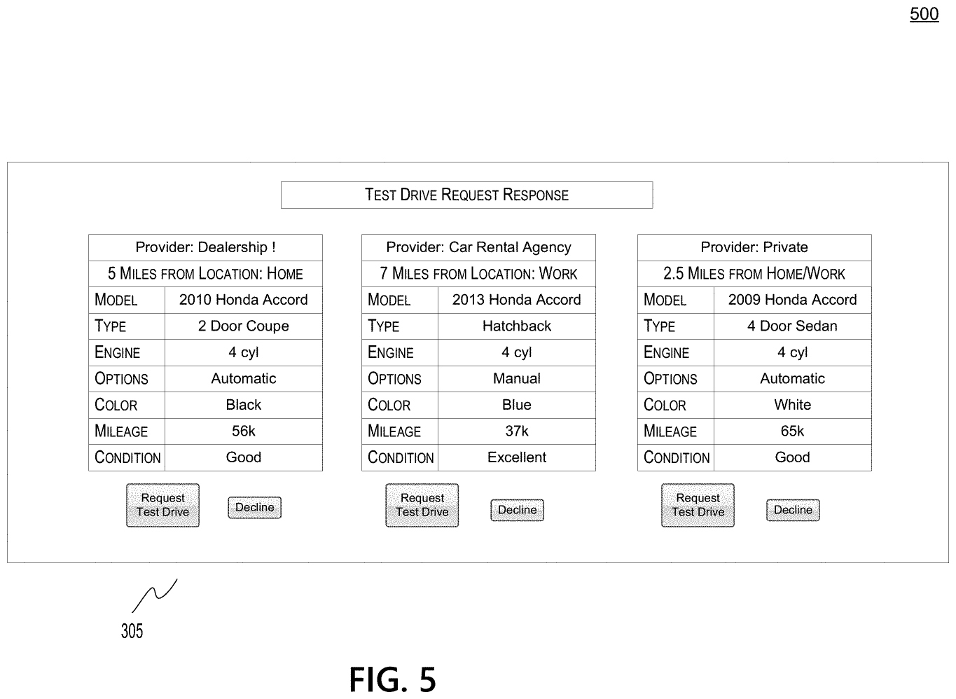

FIG. 5 shows an exemplary message that may be provided to a test drive requester, based on a test drive request made by the test drive requester using the user interface of FIG. 3. The message may include one or more vehicles that match the information provided by the user as to a particular type of vehicle to test drive, whereby FIG. 5 shows three separate test drive providers and their respective vehicles available to test drive. Test driver provider #1 is a car dealership that is 5 miles from the user's home, and has a 2010 Honda Accord that matches a request made by the user for test driving a Honda Accord in the 2009 to 2015 manufacturer year range. Test drive provider #2 is a car rental facility that is 7 miles from the user's work location, and has a 2013 Honda Accord that matches the request made by the user for test driving a Honda Accord in the 2009 to 2015 manufacturer year range. Test drive provider #3 is a private party that owns a 2009 Honda Accord, whereby the private party is located 2.5 miles from a particular point of travel of the user between the user's home and the user's place of work.

Based on the information in the message, the user may decide to test drive vehicles of one or more of test drive provider #1, test drive provider #2, and test drive provider #3, by selecting “Yes” next to the specific test drive provider in the message. In this case, the user indicated that she wants to test drive the vehicle of test drive provider #1 and the vehicle of test drive provider #3. Accordingly, test drive provider #1 and test drive provider #3 are informed of a request to test drive their vehicle via a message sent to them (e.g., email, or text message, or both), along with the optimal meeting location. Thus, the optimal meeting location for test drive provider #1 is the user's home, and the optimal meeting location for test drive provider #3 is a point of travel that the user takes to go between the user's home and the user's place of work. The test drive provider and the user may communicate directly with each other in order to determine a day, time of day, and location (the optimal meeting location, or some other agreed upon location) to conduct the test drive of the test drive provider's vehicle.

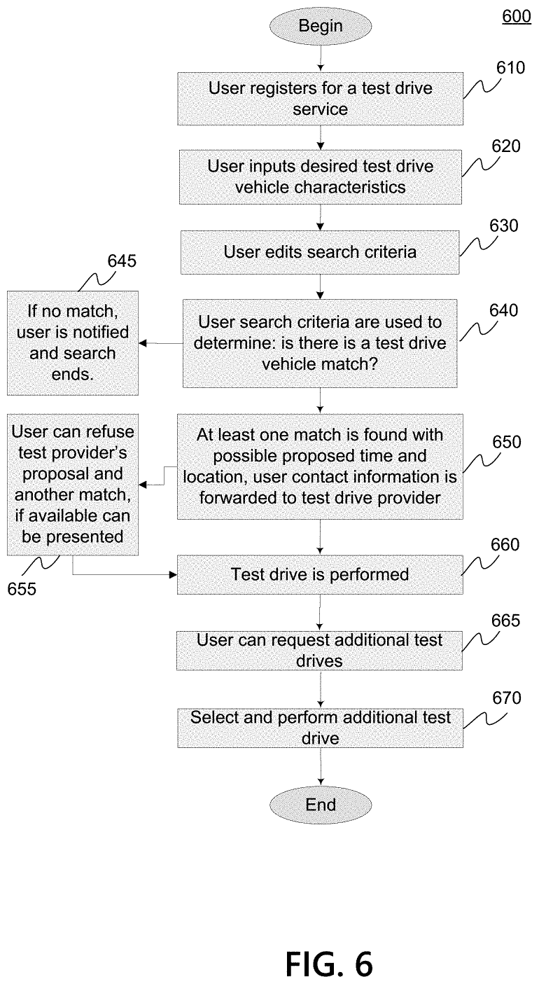

FIG. 6 depicts a flow chart of an example method 600 for facilitating a test drive request, according to one or more aspects of the disclosure. In step 610, a customer registers for a test drive service, such as using a user interface such as shown in FIG. 3. In step 620, the customer provides information of a vehicle that the user desires to test drive. This information may be a vehicle make and model and manufacture year or range of manufacture years. The information may include additional information, such as a “compact” vehicle with a 4 cylinder engine, a 2 door body, and having anti-lock braking.

In step 630, a selection of available vehicles for test drives may be expanded or compressed based on the customer-provided information. For example, if no vehicles match the vehicle make and model and manufacture year or range of manufacture years, then the range of manufacture years may be expanded to determine if any comparable vehicles meeting the specific request for a vehicle to be test driven as provided by the user.

In step 640, based on the vehicle information provided by the user, and based on information of available vehicles to be test driven as provided by test drive providers, a determination is made as to whether or not any matches exist. If no matches exist, then the user is notified as to their being no matches in step 645, and the process ends. Note that, based on the location information provided by the user and by the test drive provider, a match may be determined to not exist if a suitable meeting location cannot be found, such as where the test drive provider and the test drive requester are at least 50 miles apart from each other at all times of the day.

If at least one match exists, the test drive provider contact information of the at least one match is provided to the user in step 650, along with an optimal meeting location and an optimal meeting time. At the same or about the same time, the test drive provider associated with the match is also provided with the user contact information, so that the test drive provider and the test drive requester may directly contact each other to agree to a specific day, time of and location to conduct the test drive.

In step 655, if the user that requested the test drive does not accept any of the proposed time and location options sent by the test drive provider, the user can cancel the request due to a non-accommodation and another potential match, if one exists, is provided to the user, to enable the user to determine if a suitable test drive meeting location and day, time of day for conducting a test drive can be made. If Yes, then in step 660, the test drive is conducted at the scheduled day and time of day for the test drive. If the user desires to test drive another vehicle, then in step 665 the user may contact another test drive provider and conduct a test drive of another vehicle in step 660. If the user does not desire to test drive another vehicle, then any remaining scheduled test drives associated with the user are canceled in step 670, and the process ends.

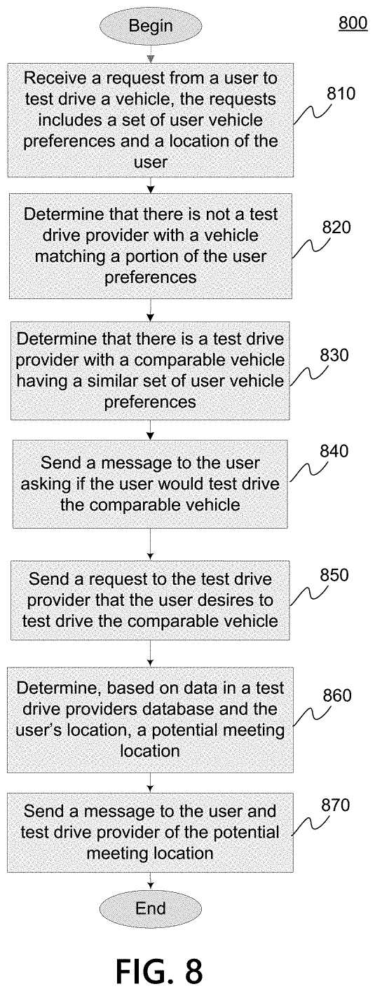

In some aspects, based on the year (or range of years), make and model of a vehicle that a customer desires to test drive, the test drive application may access a database of vehicle information, such as one obtained from Kelley Blue Book, to determine comparable vehicles that are similar to the year (or range of years), make and model of the vehicle that the customer desires to test drive. For example, if the database of vehicle information indicates that 2010 Honda Odyssey vans have a very similar body style and vehicle options and driving experience as 2004 to 2009 Honda Odysseys, and if the customer inputted a request to test drive a Honda Odyssey in the manufacturer year range of 2008 to 2010, then the system may inform the customer that 2004 to 2008 Honda Odyssey vehicles are very similar to the specific test drive vehicles that the customer desires to test drive. The customer may then decide to expand his/her test drive vehicle input to cover the manufacture years from 2004 to 2010, or decide to stick with his/her original selection of 2008 to 2010 Honda Odyssey vans to test drive. The database of vehicle information that may be used to determine comparable vehicles may include information of driver surveys of vehicles that indicate which vehicles have the same or very similar driving experiences as other vehicles (e.g., a survey that indicates that a user who drove a 1999 Dodge Caravan and a 2010 Dodge Caravan considered them very similar). Also, the system may indicate different makes and models that provide a same or similar driving experience as the specific vehicle make and model that the user has requested a test drive, where such a vehicle would be considered a comparable vehicle as offered in step 830 of flowchart in method 800 in FIG. 8. For example, a 2010 Toyota Tercel may have a very same vehicle type and driving experience as a 2010 Honda Civic, and thus the user may be prompted with a suggestion to expand his/her test driving parameters to include not only 2010 Toyota Tercels, but also to include 2010 Honda Civics.

In some aspects, the system keeps track of the number of test drives made by a user within a particular time period, such as the number of test drives made by a user within the past seven (7) days. If the number of test drives exceeds a specific number, such as five (5) test drives, then the user is informed that he/she cannot set up any more test drives using the test drive application until a specific time period, such as two (2) days, has passed. This prevents abuse of the system by users, and allows for a suitable number of vehicles to be available for test drives at any particular point in time. However, in some scenarios such a limitation would not be applicable, for example, if the user is directly paying the vehicle owner to test drive the vehicle, there is no real reason to limit the test drives, at least from a monetary standpoint. In some aspects, the more test drives made by a user within a particular time period, the higher the fee charged to the user for setting up test drives using the test drive application.

In some aspects, when the test drive provider is a ride sharing driver, such as a driver working for Lyft™ or Uber™, when a vehicle owned by the ride sharing driver matches the specific vehicle characteristics of a vehicle desired to be test driven by a user of the test drive application, the ride sharing driver is notified of this request. The request may be converted into a normal ride sharing request on the Lyft™ or Uber™ iphone or android application, with a change made in which the ride sharing driver is informed that, for this ride share, the person requesting a drive to another location wants to drive the vehicle and not be driven by the ride sharing driver. This may be informed by way of a specific ride request condition included in the ride sharing request made by the user or by a request for ride sharing service created via a computer application associated with the ride sharing service.

The ride sharing driver may then decide whether or not he/she will accept this request, and if so, the ride sharing driver may drive to a location where the user is located, and then allow the user to drive the vehicle. In some aspects, the ride sharing drive may indicate whether or not he/she must be in the vehicle while the user is driving his/her vehicle, or whether the user may drive the vehicle without the Uber™ or Lyft™ driver being in the vehicle. For insurance purposes, it may be the case that the Uber™ or Lyft™ driver must be in the vehicle at all times. However, in a non-ride sharing scenario, there may also be the option for the test drive provider to remain in the vehicle, especially if the vehicle is not being returned to the original pick-up location.

One or more aspects described herein may provide systems for facilitating vehicle test drives. This may have the benefit of reducing the effort involved in a test drive requester and a test drive provider determining an appropriate day, time of day, and meeting location for conducting a test drive, while reducing the strain on the test drive requester. For example, a consumer may be able to quickly locate and access several vehicles for a test drive using a mobile application, which may have the advantage of allowing a user to determine an appropriate vehicle to purchase, such as from a used car dealership, from a car rental facility, or from a private party using Craigslist or some other person-to-person sales web site. Also, this enables a consumer to efficiently set up test drives, without having to go to one or more car dealerships and have to deal with the hassles associated with strong-arm sales pitches at each of those car dealerships.

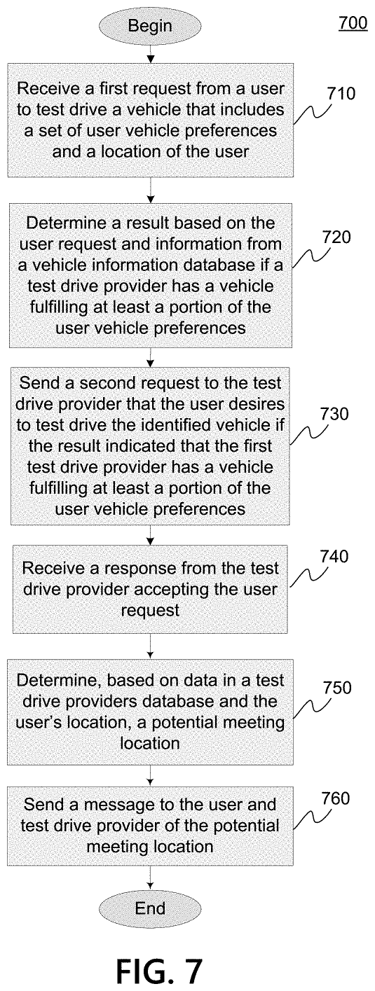

FIG. 7 shows an exemplary embodiment of a method 700 for requesting a test drive from a test drive provider, according to an embodiment. Method 700 begins at step 710 where an input is received from a computing device associated with a user. The input includes a request to test drive a vehicle and also a location that is associated with the user. The user's location will later be used to facilitate selecting a location for a test drive. Further, the request to test drive a vehicle also includes a set of user vehicle preferences pertaining to the vehicle that the user desires to test drive. As discussed in FIG. 3 above, the user vehicle preferences can include data such as the desired manufacturer of the vehicle, the model year of the vehicle, or a range of model years. The preferences can also include a specific model of vehicle, or just the type and detail other features such as the size of engine, color, required or desired options, mileage criteria and condition of the vehicle. The user preferences can be multi-factored or fairly general, for example, a SUV manufactured in the past 5 years.

In step 720 the method continues by performing a comparison of the user request and vehicle preferences with information from a vehicle information database to identify one or more test drive providers that possess a vehicle that fulfills at least a portion of the user vehicle preferences. Thus, as discussed above, if a user is looking for a late model compact with an automatic transmission, and also possibly specifies a color and other desired options, if a vehicle in the vehicle information database matches at least one of the user's vehicle preferences, then that identified vehicle can be presented to the user as a candidate for a test drive. However, if the comparison does not identify a test drive provider that has a vehicle fulfilling at least a portion of the user vehicle preferences, then the user can be informed of the lack of a match and could be presented with a comparable vehicle to test drive.

In step 730, given that the vehicle information database has identified at least one vehicle that fulfills the user's request criteria, the test provider, or multiple providers, would be sent a request informing the test drive provider(s) that a user has requested a test drive in a vehicle that has certain characteristics, which the vehicle information database has identified certain test drive providers as having possession of such a vehicle. The test drive providers then have the option of agreeing to provide the vehicle for a test drive, or to decline.

In step 740 one or more of the test drive providers responds to the request in a positive manner, accepting the request to test drive a particular vehicle. In step 750, given that the user's location is known and that the location of the test drive provider is also known as such information is stored within a test drive providers database, the method continues by determining potential meeting locations. In addition, given that the test drive providers database also includes other information such as operating hours (or preferred hours), the determining of potential meeting location could also be accompanied by potential meeting times. In step 760 a message is generated by the system to the user suggesting potential meeting places and possibly potential meeting times. The method then ends.

FIG. 8 shows an exemplary embodiment of a method 800 for requesting a test drive from a test drive provider, according to an embodiment. Method 800 begins at step 810 where an input is received from a computing device associated with a user. The computing device may be a mobile device such as mobile device 225 or a personal computer such as computing device 101. The input includes a request to test drive a vehicle and also a location that is associated with the user. The user's location will later be used to facilitate selecting a location for a test drive. Further, the request to test drive a vehicle also includes a set of user vehicle preferences pertaining to the vehicle that the user desires to test drive. As discussed in FIG. 3 above, the user vehicle preferences can include data such as the desired manufacturer of the vehicle, the model year of the vehicle, or a range of model years.

In step 820 the method continues by performing a comparison of the user request and vehicle preferences with information from a vehicle information database to identify one or more test drive providers that possess a vehicle that fulfills at least a portion of the user vehicle preferences. Thus, if a user specifies a fairly specific request such as a 2013 Honda Accord with less than 5,000 miles, it is possible that none of the test drive providers in the area would have such a vehicle. In this case, the determination would be made that there is no match as no test drive provider can provide a vehicle that matches all of the user criteria for a test drive vehicle, and further that no test drive provider can provide a vehicle that matches even a portion of the factors.

In step 830 there is a determination made that a test drive provider that possesses a vehicle having a similar set of user vehicle preferences, or in the alternative the user can provide a revised set of user vehicle preferences. Similar set of user vehicle preferences means that while the criteria may not be exact, they are close or similar. For example, a test drive provider may have a 2018 Honda Accord, and that 2018 Honda Accord also has less than 5,000 miles on it. Or if the user requested a V-12 2017 Viper, of which no test drive provider had such a vehicle, but did have a V-10 2016 Viper that would qualify as a comparable vehicle.

In step 840, given that a comparable vehicle has been identified, the user is sent a message asking if they would like to test drive the comparable vehicle. If the user wishes to pursue a test drive then in step 850 a request is sent to the test drive provider informing the test drive provider that the user wishes to proceed with the test drive of the comparable vehicle.

In step 860, given that the user's location is known and that the location of the test drive provider is also known as such information is stored within a test drive providers database, the method continues be determining potential meeting locations. In addition, given that the test drive providers database also includes other information such as operating hours, the determining of potential meeting location could also be accompanied by potential meeting times. In step 870 a message is generated by the system to the user suggesting potential meeting places and possibly potential meeting times. The method then ends.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method comprising:
causing, by a server, a test drive application to run on a computing device associated with a user;
receiving, via the test drive application, a first request to determine a vehicle to test drive, wherein the first request comprises a set of user vehicle preferences pertaining to a vehicle that the user desires to test drive and a location associated with the user;
causing, based on the first request, the test drive application to access a vehicle information database associated with the server, to determine a vehicle provider having a vehicle fulfilling at least a portion of the set of user vehicle preferences, wherein the vehicle provider is associated with a second computer application different from the test drive application;
presenting to the user, via the test drive application, the vehicle of the vehicle provider;
receiving, via the test drive application, a second request indicating that the user desires to test drive the vehicle of the vehicle provider;
modifying the second request to generate a third request that is received by the vehicle provider via the second computer application, wherein the third request comprises a notification of the second request and a condition associated with the second computer application;
receiving a response, from the vehicle provider, indicating that the vehicle provider accepts the second request of the user to test drive the vehicle of the vehicle provider;
automatically determining, by the server, to send an electronic message, regarding a potential meeting location, to the user and to the vehicle provider, wherein the potential meeting location is determined based on a location of the vehicle provider and the location associated with the user; and
sending, by the server, the electronic message, regarding the potential meeting location, to the user and to the vehicle provider.

2. The computer-implemented method of claim 1, wherein one or more of:
the location of the vehicle provider or
the location associated with the user, is associated with a time portion of a day.

3. The computer-implemented method of claim 1, wherein the second computer application comprises one or more of:
a car sharing application, or
a ride sharing application.

4. The computer-implemented method of claim 1, wherein the location associated with the user comprises a plurality of locations, and wherein each of the plurality of locations is associated with a time portion of a day.

5. The computer-implemented method of claim 1, wherein the potential meeting location is along a travel route from which the user normally traverses to go between a first location and a second location.

6. The computer-implemented method of claim 1, wherein the potential meeting location is along a travel route from the location of the user to a location of the vehicle provider.

7. The computer-implemented method of claim 1, wherein information stored in the vehicle information database comprises information obtained from surveys provided by users who have test driven vehicles of different manufacturers, model years, and models.

8. The computer-implemented method of claim 1, further comprising:
determining that the vehicle provider does not have a vehicle fulfilling at least a portion of the set of user vehicle preferences, wherein the set of user vehicle preferences comprises one or more of a vehicle manufacturer, a vehicle model year or a range of vehicle model years, or a vehicle model;
determining, based on information stored in the vehicle information database, at least one other vehicle provider with a comparable vehicle having a similar set of user vehicle preferences; and
sending a message to the user requesting whether the user would like to test drive the comparable vehicle.

9. The computer-implemented method of claim 1, further comprising:
determining a number of times that users have test driven vehicles associated with the vehicle provider within a predetermined time period; and
providing a financial compensation to the vehicle provider based on a predetermined number of times.

10. The computer-implemented method of claim 1, wherein the second computing application comprises a ride sharing application and the vehicle provider is associated with a ride sharing driver providing a ride sharing service, and
wherein the condition associated with the ride sharing application indicates that the user, not the ride sharing driver, drives the vehicle of the vehicle provider.

11. An apparatus comprising:
one or more processors; and
memory storing instructions that, when executed by the one or more processors, cause the one or more processors to perform:
causing a test drive application to run on a computing device associated with a user;
receiving, via the test drive application, a first request to determine a vehicle to test drive, wherein the first request comprises a set of user vehicle preferences pertaining to a vehicle that the user desires to test drive and a location associated with the user;
causing the test drive application to access a vehicle information database associated with the apparatus to compare the set of user vehicle preferences with information stored in the vehicle information database;
comparing the location associated with the user with locations of vehicle providers;
determining, based on the comparing the set of user vehicle preferences with information stored in the vehicle information database and the comparing the location associated with the user with the locations of the vehicle providers, that a determined vehicle provider of the vehicle providers possesses a vehicle fulfilling at least a portion of the set of user vehicle preferences, wherein the determined vehicle provider comprises a dealership, rental facility, private party, or a ride sharing service, and wherein the determined vehicle provider is associated with a second computer application different from the test drive application;
presenting to the user, via the test drive application, the vehicle of the determined vehicle provider;
receiving, via the test drive application, a second request indicating that the user desires to test drive the vehicle of the determined vehicle provider;
modifying the second request to generate a third request that is received by the determined vehicle provider via the second computer application, wherein the third request comprises a notification of the second request and a condition associated with the second computer application;
receiving a response, from the determined vehicle provider, indicating that the determined vehicle provider accepts the second request of the user to test drive the vehicle of the determined vehicle provider;
automatically determining to send an electronic message, regarding a potential meeting location, to the user and to the determined vehicle provider, wherein the potential meeting location is determined based on the location associated with the user and a location of the determined vehicle provider; and
sending the electronic message, regarding the potential meeting location, to the user and to the determined vehicle provider.

12. The apparatus of claim 11, wherein the information stored in the vehicle information database comprises information obtained from surveys provided by users who have test driven vehicles of different manufacturers, model years, and models.

13. The apparatus of claim 11, further comprising:
determining a number of times that users have test driven vehicles associated with the determined vehicle provider within a predetermined time period; and
provide financial compensation to the determined vehicle provider based on the determined number of times.

14. The apparatus of claim 11, further comprising sending, to the computing device associated with the user, a message including a request for a revised set of user vehicle preferences.

15. The apparatus of claim 11, wherein the location of the determined vehicle provider comprises a plurality of vehicle provider locations, and wherein each of the plurality of vehicle provider locations is associated with a time portion of a day,
wherein the location associated with the user comprises a plurality of user locations, and wherein each of the plurality of user locations is associated with a time portion of a day, and
wherein the set of user vehicle preferences comprises one or more of a vehicle manufacturer, a vehicle model year or a range of vehicle model years, or a vehicle model.

16. The apparatus of claim 11, wherein the first request comprises a requested time to test drive the vehicle.

17. The apparatus of claim 11, wherein the potential meeting location is along a travel route from which the user normally traverses to go between a first location and a second location.

18. The apparatus of claim 11, wherein the potential meeting location is along a travel route from the location of the user and a location of the determined vehicle provider.

19. The apparatus of claim 11, wherein the second computing application comprises a ride sharing application and the determined vehicle provider is associated with a ride sharing driver providing a ride sharing service, and
wherein the condition associated with the ride sharing application indicates that the user, not the ride sharing driver, drives the vehicle of the determined vehicle provider.

20. One or more non-transitory media storing instructions that, when executed by one or more processors, cause the one or more processors to perform steps comprising:
causing a test drive application to run on a computing device associated with a user;
receiving, via the test drive application, a first request to determine a vehicle to test drive, wherein the first request comprises a set of user vehicle preferences pertaining to a vehicle that the user desires to test drive and a location associated with the user, and a requested time to test drive the vehicle, wherein the set of user vehicle preferences comprises one or more of a vehicle manufacturer, a vehicle model year or a range of vehicle model years, or a vehicle model, and wherein the first request further comprises contact information of the user;
causing the test drive application to access a vehicle information database to determine, based on the first request and information stored in the vehicle information database, a vehicle provider having a vehicle fulfilling at least a portion of the set of user vehicle preferences, wherein the vehicle provider is associated with a second computer application different from the test drive application;
presenting to the user, via the test drive application, the vehicle of the vehicle provider;
receiving, via the test drive application, a second request indicating that the user desires to test drive the vehicle of the vehicle provider;
modifying the second request to generate a third request that is received by the vehicle provider via the second computer application, wherein the third request comprises a notification of the second request and a condition associated with the second computer application;
receiving a response, from the vehicle provider, indicating that the vehicle provider accepts the second request of the user to test drive the vehicle of the vehicle provider;
automatically determining to send an electronic message, regarding a potential meeting location, to the user and to the vehicle provider, wherein the potential meeting location is determined based on a location of the vehicle provider and the location associated with the user, and wherein the vehicle information database comprises information obtained from surveys provided by users who have test driven vehicles of different manufacturers, model years, and models;
determining a number of times that the user has test driven vehicles associated with the vehicle provider within a predetermined time period and providing a financial compensation to the vehicle provider based on a predetermined number of times; and
sending the electronic message, regarding the potential meeting location, to the user and to the vehicle provider, wherein the potential meeting location is along a travel route from which the user normally takes to go between a first location and a second location or along a travel route from the location associated with the user and the location of the vehicle provider.
